(19) United States
(12) Patent Application Publication
(10) Pub. No.: US 2026/0197880 A1
(43) Pub. Date: Jul. 9, 2026

(54) POINT-TO-POINT HEADPHONE COMMUNICATION SYSTEM

(71) Applicant: Samsung Electronics Co., Ltd., Suwon-si (KR)

(72) Inventors: Djordje Preradovic, Oakland, MI (US); Hossein Najaf-Zadeh, Prosper, TX (US)

(21) Appl. No.: 19/014,087

(22) Filed: Jan. 8, 2025

(51) Int. Cl. H04W 76/10; G10L 15/22; H04L 9/40; H04S 7/00; H04W 64/00

(52) U.S. Cl. CPC H04W 76/10; G10L 15/22; H04L 63/0861; H04S 7/302; H04W 64/003; G10L 2015/223

(57) ABSTRACT

Methods and systems for point-to-point wearable communication using wireless technology. A computer-implemented method includes receiving a command at a first wearable audio device; selecting, based on the command received at the first wearable audio device and a sensor input, at least one second wearable audio device; initiating, based on the command received at the first wearable audio device, one or more wireless communication channels from the first wearable audio device to the selected at least one second wearable audio device; and transmitting an audio signal from the first wearable audio device to the selected at least one second wearable audio device using the one or more wireless communication channels.

### TECHNICAL FIELD

The present disclosure relates generally to wireless communication systems. More specifically, the present disclosure relates to a system and method for point-to-point wearable communication using wireless technology.

### BACKGROUND

Wearable audio devices, such as headphones, earbuds, and headsets, may effectively allow a user to listen to audio without releasing the audio into the environment, allowing for increased privacy. Additionally, the wearable audio devices may include passive and active noise cancellation (ANC). In some cases, adaptive ANC is used to optimize sound quality produce by the wearable device. However, wearable audio devices, particularly those equipped with ANC, present challenges for users in environments where the user is attempting to communicate with others. In some cases, the wearable audio devices impinge on effective communication between users. Although users may remove the wearable audio devices, noisy environments may still present a challenge.

Accordingly, there is a need for systems and methods for improved point-to-point wearable communication systems that overcome these challenges.

### SUMMARY

The present disclosure relates generally to wireless communication systems and, more specifically, the present disclosure relates to a system and method for point-to-point wearable communication using wireless technology.

In one embodiment, a computer-implemented method is provided. The computer-implemented method includes receiving a command at a first wearable audio device; selecting, based on the command received at the first wearable audio device and a sensor input, at least one second wearable audio device; initiating, based on the command received at the first wearable audio device, one or more wireless communication channels from the first wearable audio device to the selected at least one second wearable audio device; and transmitting an audio signal from the first wearable audio device to the selected at least one second wearable audio device using the one or more wireless communication channels.

In another embodiment, an electronic device is provided. The electronic device includes a transceiver configured to receive a signal, a sensor configured to receive a sensor input, and a processor operably coupled to the transceiver and the sensor. The processor is configured to cause the electronic device to receive a command; select, based on the command received and a sensor input, at least one second wearable audio device; initiate, based on the command received, one or more wireless communication channels from the first wearable audio device to the selected at least one second wearable audio device; and transmit an audio signal to the selected at least one second wearable audio device using the one or more wireless communication channels.

In yet another embodiment, a non-transitory computer-readable medium is provided. The non-transitory computer-readable medium includes program code, that when executed by at least one processor of an electronic device, causes the electronic device to receive a command, select, based on the command received and a sensor input, at least one second wearable audio device, initiate, based on the command received, one or more wireless communication channels from the first wearable audio device to the selected at least one second wearable audio device, and transmit an audio signal to the selected at least one second wearable audio device using the one or more wireless communication channels.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example access point according to various embodiments of the present disclosure;

FIG. 2B illustrates an example station according to various embodiments of this disclosure;

FIG. 3 illustrates an example point-to-point communication system according to various embodiments of the present disclosure;

FIG. 4 illustrates an example wearable point-to-point communication method for wearable audio devices according to various embodiments of the present disclosure;

FIG. 5 illustrates an example block diagram of a configuration of a wearable audio device according to various embodiments of the present disclosure;

FIG. 6 illustrates an example voice detection method according to various embodiments of the present disclosure;

FIG. 7 illustrates an example point-to-point communication method according to various embodiments of the present disclosure;

FIG. 8 illustrates an example block diagram of a configuration of a voice recognition system according to various embodiments of the present disclosure;

FIG. 9 illustrates an example point-to-point communication method for wearable audio devices according to various embodiments of the present disclosure;

FIG. 10 illustrates an example block diagram of a configuration of a spatial audio module according to various embodiments of the present disclosure;

FIG. 11 illustrates an example point-to-point communication method for wearable audio devices according to various embodiments of the present disclosure; and

FIG. 12 illustrates an example communication system according to various embodiments of the present disclosure.

### DETAILED DESCRIPTION

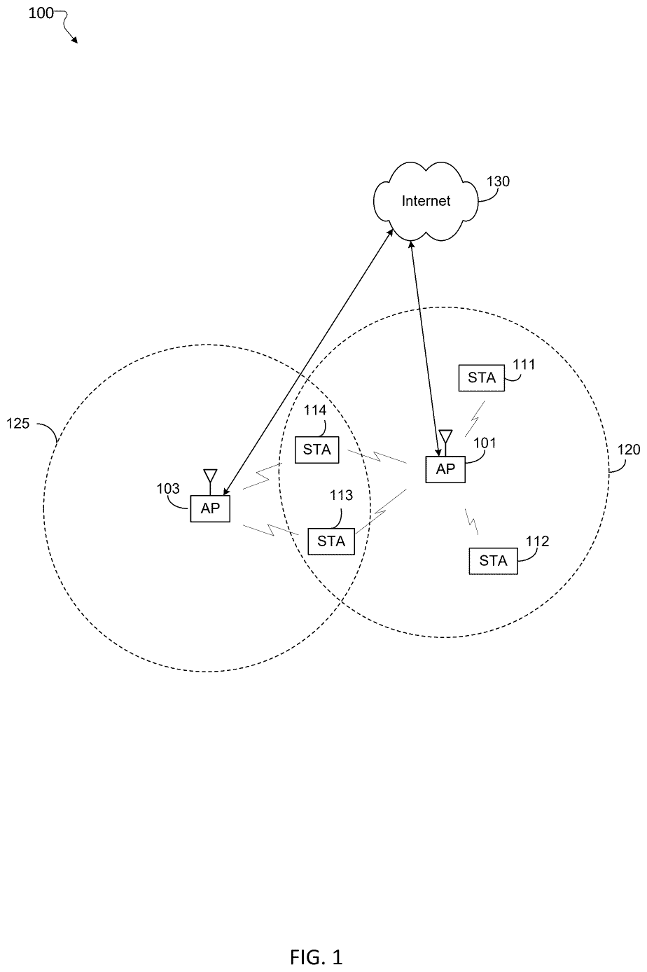

FIG. 1 through FIG. 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, wearable audio devices, such as headphones, earbuds, and headsets, may effectively allow a user to listen to audio without releasing the audio into the environment, allowing for increased privacy. Additionally, the wearable audio devices may include passive and active noise cancellation (ANC). In some cases, adaptive ANC is used to optimize sound quality produce by the wearable device. However, wearable audio devices, particularly those equipped with ANC, present challenges for users in environments where the user is attempting to communicate with others.

Accordingly, the present disclosure provides systems and methods for point-to-point wearable communication. As described herein, the present disclosure includes a wearable audio device, e.g., headphones, that select at least one second wearable audio device based on a command or input from a user. The wearable audio device then establishes a communication channel, directly or through proxy devices, with the at least one second wearable audio device. The wearable audio device may incorporate spatial audio to select the one or more secondary audio devices. Selection may also be accomplished using pair requests between the wearable audio device and the one or more secondary audio devices. The wearable audio devices of the present disclosure allow for a point-to-point or multi-point communication, e.g., a direct link between two or more wearable audio devices, resulting in a direct, exclusive connection between the wearable audio devices.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of the present disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111, 112, 113, and 114 within a coverage area 120 of the AP 101. The APs 101-103 may communicate with each other and with the STAs 111-114 using Wi-Fi, Ultra-Wide Band (UWB), short-range RF communication such as Bluetooth technology, or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for estimating a user velocity based on multi-antenna WiFi signals in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

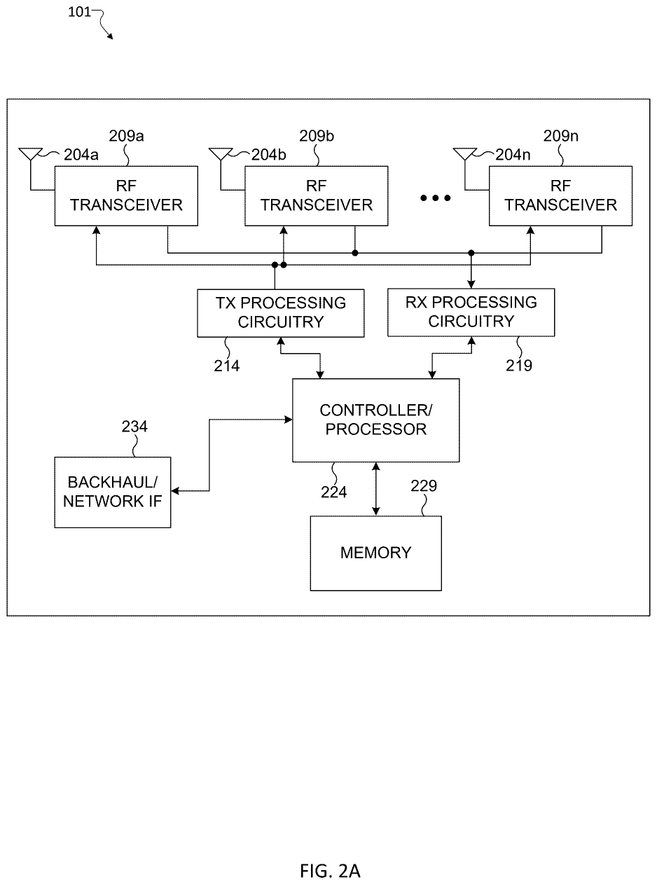

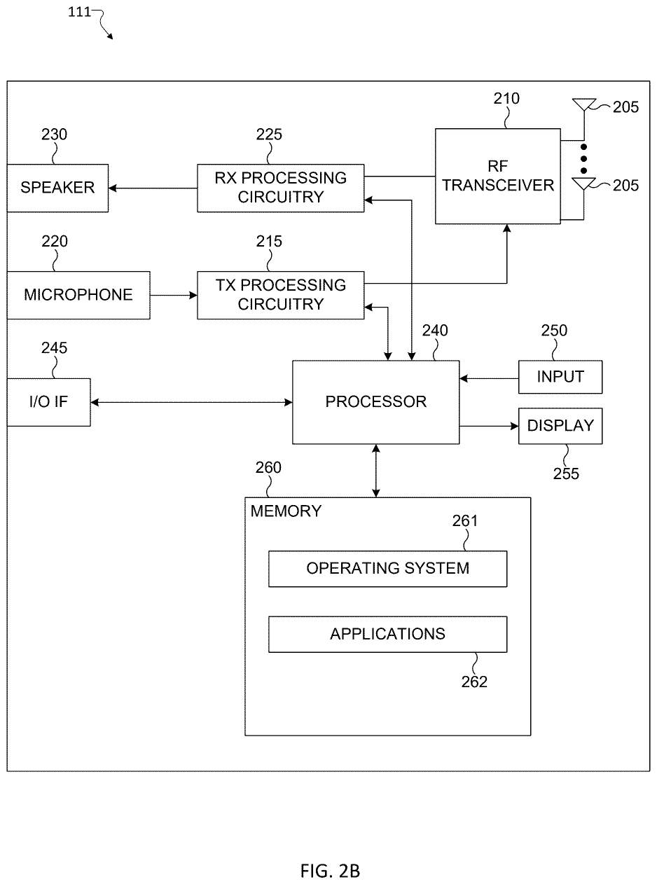

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of the present disclosure to any particular implementation of an AP.

The AP 101 includes multiple antennas 204a-204n, multiple RF transceivers 209a-209n, transmitter processing circuitry 214, and receiver processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the receiver processing circuitry 219, which generates processed baseband signals by filtering, decoding, and/or digitizing the baseband or IF signals. The receiver processing circuitry 219 transmits the processed baseband signals to the controller/processor 224 for further processing.

The transmitter processing circuitry 214 receives analog or digital data (such as voice data, web data, e-mail, or interactive video game data) from the controller/processor 224. The transmitter processing circuitry 214 encodes, multiplexes, and/or digitizes the outgoing baseband data to generate processed baseband or IF signals. The RF transceivers 209a-209n receive the outgoing processed baseband or IF signals from the transmitter processing circuitry 214 and up-converts the baseband or IF signals to RF signals that are transmitted via the antennas 204a-204n.

The controller/processor 224 may include one or more processors or other processing devices that control the overall operation of the AP 101. For example, the controller/processor 224 could control the reception of forward channel signals and the transmission of reverse channel signals by the RF transceivers 209a-209n, the receiver processing circuitry 219, and the transmitter processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including estimating a user velocity based on multi-antenna WiFi signals. In some embodiments, the controller/processor 224 includes at least one microprocessor or microcontroller. The controller/processor 224 is also capable of executing programs and other processes resident in the memory 229, such as an OS. The controller/processor 224 may move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for estimating a user velocity based on multi-antenna WiFi signals. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of transmitter processing circuitry 214 and a single instance of receiver processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of the present disclosure to any particular implementation of a STA.

The STA 111 includes antenna(s) 205, a radio frequency (RF) transceiver 210, transmitter processing circuitry 215, a microphone 220, and receiver processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the receiver processing circuitry 225, which generates a processed baseband signal by filtering, decoding, and/or digitizing the baseband or IF signal. The receiver processing circuitry 225 transmits the processed baseband signal to the speaker 230 (such as for voice data) or to the controller/processor 240 for further processing (such as for web browsing data).

The transmitter processing circuitry 215 receives analog or digital voice data from the microphone 220 or other outgoing baseband data (such as web data, e-mail, or interactive video game data) from the controller/processor 240. The transmitter processing circuitry 215 encodes, multiplexes, and/or digitizes the outgoing baseband data to generate a processed baseband or IF signal. The RF transceiver 210 receives the outgoing processed baseband or IF signal from the transmitter processing circuitry 215 and up-converts the baseband or IF signal to an RF signal that is transmitted via the antenna(s) 205.

The controller/processor 240 may include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the receiver processing circuitry 225, and the transmitter processing circuitry 215 in accordance with well-known principles. In some embodiments, the controller/processor 240 includes at least one microprocessor or microcontroller.

The controller/processor 240 is also capable of executing other processes and programs resident in the memory 260, such as operations for determining a position of a tag based on anchor signals. The controller/processor 240 may move data into or out of the memory 260 as required by an executing process. In some embodiments, the controller/processor 240 is configured to execute a plurality of applications 262. The controller/processor 240 may operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 may use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

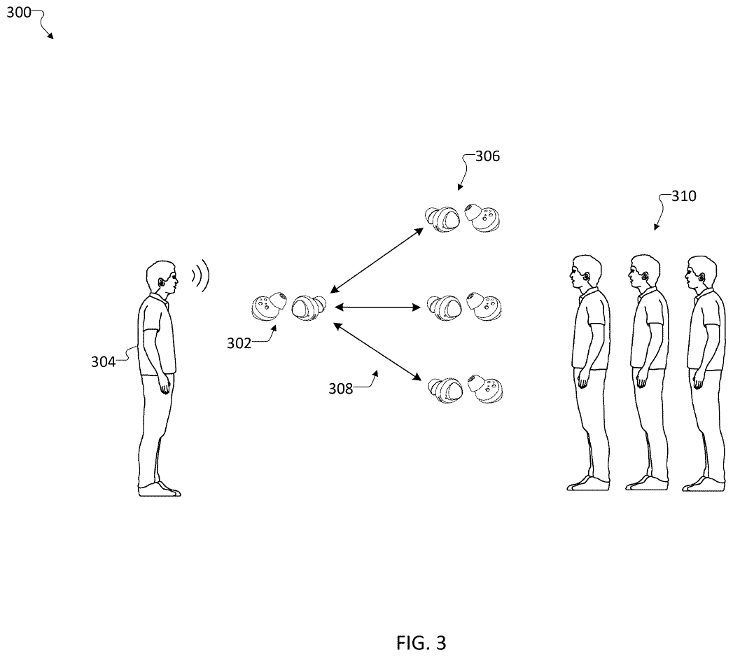

FIG. 3 illustrates an example point-to-point communication system 300 according to various embodiments of the present disclosure. The embodiment of the point-to-point communication system 300 shown in FIG. 3 is for illustration only. Other embodiments of the point-to-point communication system 300 could be used without departing from the scope of this disclosure.

The point-to-point communication system 300 includes a first wearable audio device 302, e.g., worn by a user 304, and configured to receive a command from the user 304. Upon receiving a command from the user 304, the first wearable audio device 302 may select at least one second wearable audio device 306, each worn by other users 310 and initiate one or more wireless communication channels 308 to the selected at least one second wearable audio device 306. The first wearable audio device 302 and the at least one second wearable audio device 306 may each be an electronic device, such as headphone, earbud, or headset, that is configured similarly to the STA 111-114 of FIGS. 1 and 2B and may be operatively coupled to an AP 101, such as a mobile phone or Wi-Fi access point. Upon establishing the one or more wireless communication channels 308, the first wearable audio device 302 may transmit an audio signal from the first wearable audio device 302 to the selected at least one second wearable audio device 306.

As described in more detail below, one or more of the first wearable audio device 302 may include circuitry or programming for establishing the one or more wireless communication channels 308 with the at least one second wearable audio device 306. Although FIG. 3 illustrates one example of a point-to-point communication system 300, various changes may be made to FIG. 3. For example, the point-to-point communication system 300 could include any number of first wearable audio device 302 and any number of at least one second wearable audio device 306 in any suitable arrangement.

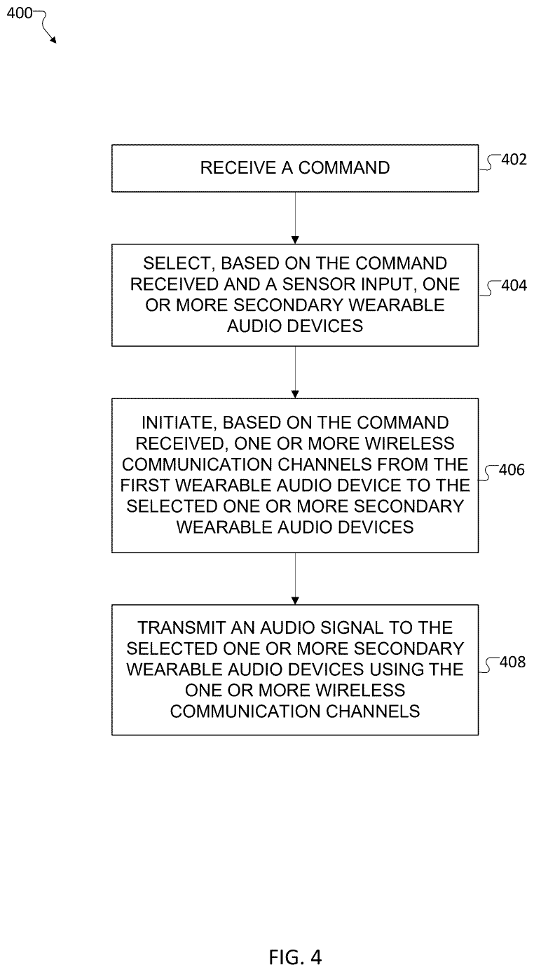

FIG. 4 illustrates an example wearable point-to-point communication method 400 for wearable audio devices according to various embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions.

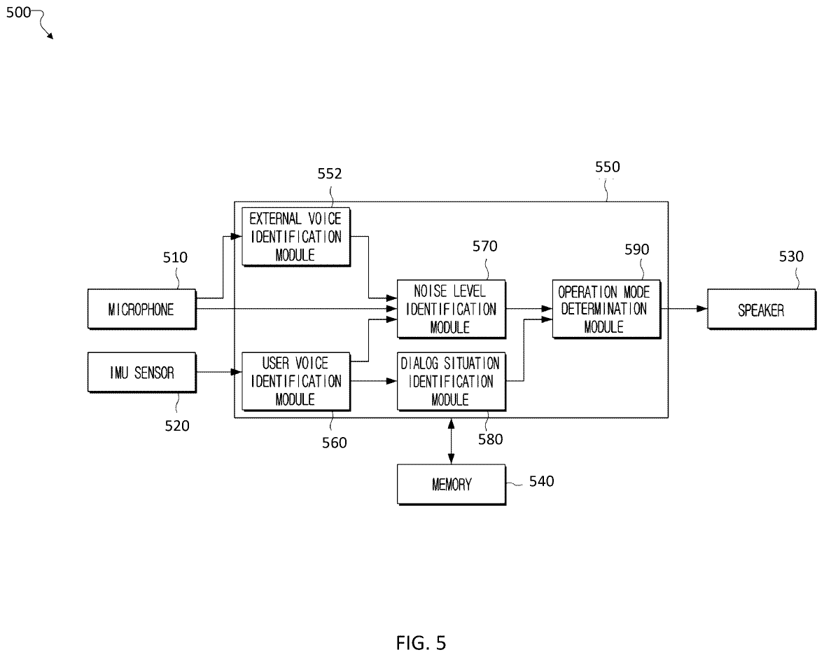

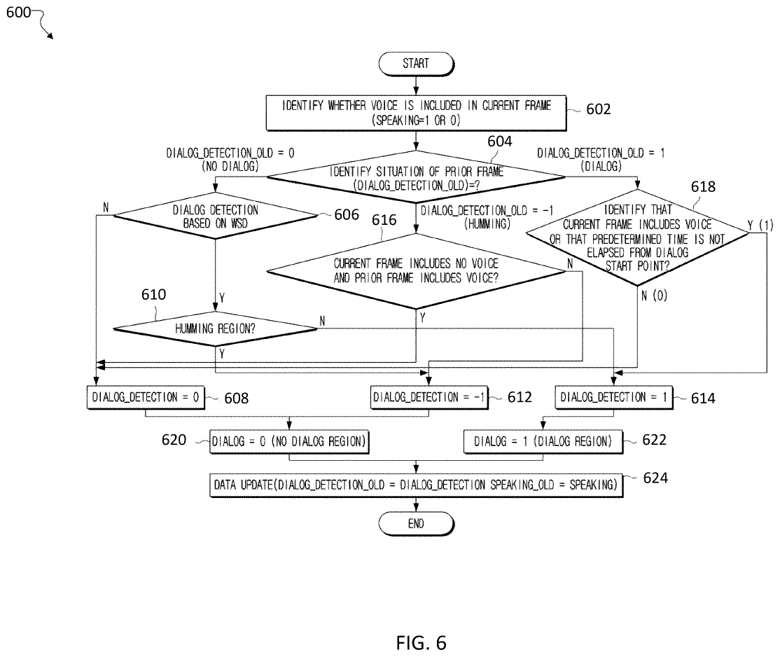

At operation 402, an electronic device, e.g., the first wearable audio device 302, may receive a command. For example, the first wearable audio device 302 may receive a command by a button press, such as when a user 304 presses a button communicatively coupled to the first wearable audio device 302, either directly or indirectly, such as through a connected device. Alternatively, the first wearable audio device 302 may be configured to receive a command from a user 304 that is a voice command as discussed in FIGS. 5 and 6.

FIG. 5 illustrates an example block diagram of a configuration of a wearable audio device 500 according to various embodiments of the present disclosure. For ease of explanation, the wearable audio device 500 will be described as the first wearable audio device 302 of FIG. 3, however, the wearable audio device 500 could be described as the at least one second wearable audio device 306 and may be implemented using any other suitable device or system. The embodiment of the wearable audio device 500 shown in FIG. 5 is for illustration only. Other embodiments of the wearable audio device 500 could be used without departing from the scope of this disclosure.

As shown in FIG. 5, the wearable audio device 500 may include a microphone 510, an IMU sensor 520, a speaker 530, a memory 540 and a processor 550. The wearable audio device 500 according to an embodiment may be implemented as various wearable audio devices, such as wireless earphones, wired earphones, or a headset. In addition, two wearable audio devices 500 may be implemented and communicatively coupled to operate as one unit, such as when a user wears one in each ear.

The microphone 510 may be configured to receive noise around the wearable audio device. In detail, the microphone 510 may use a microphone to receive the noise around the wearable audio device 500 and convert the received noise into an electrical data signal. In this case, the microphone 510 may transmit the converted data signal to the processor 550.

In an embodiment, the microphone 510 may include an external microphone (not shown) disposed on the wearable audio device 500 to be positioned outside the ear of the user. The external microphone may be disposed to be positioned outside the ear of the user and configured to receive the external noise.

In addition, the wearable audio device 500 may further include an internal microphone (not shown). The internal microphone may be positioned inside the ear of the user and configured to receive the spoken voice of the user. For example, two external microphones may be implemented, and one internal microphone may be implemented. However, an embodiment is not limited thereto, and the various numbers of external microphones and internal microphones may be implemented.

The IMU sensor 520 may be configured to receive a bone conduction signal corresponding to vibration generated in the face of the user. That is, the IMU sensor 520 may receive information on the vibration generated from the skin or bone of the user and convert the received vibration into a waveform signal. In this case, the IMU sensor 520 may transmit the converted waveform signal to the processor 550, providing a sensor input to the wearable audio device 500. For example, the IMU sensor 520 may include an acceleration sensor capable of measuring the bone conduction signal. However, an embodiment is not limited thereto and may include various sensors capable of measuring the bone conduction signal.

For example, if the wearable audio device 500 is worn on the ear of the user, the IMU sensor 520 may be positioned in the wearable audio device 500 to be inserted in the ear of the user canal. In addition, the IMU sensor 520 may receive the bone conduction signal conducted by the user's skin or bone. However, an embodiment is not limited thereto, and the IMU sensor 520 may be disposed to be in contact with an outer housing of the wearable audio device 500 that is inserted in the ear canal of the user.

The processor 550 of the wearable audio device 500 of FIG. 5 may be configured to perform a voice detection method to determine whether a command is received by a user.

The processor 550 may include an external voice identification module 552, a user voice identification module 560, a noise level identification module 570, a dialog situation identification module 580 and an operation mode determination module 590, and each module may be stored in the memory 540.

The external voice identification module 552 may identify whether the external voice is included in a noise signal received by the external microphone using a voice activity detection (VAD) technique. The VAD technique is a technique for distinguishing a voice and silence from each other in a noise signal and may also be referred to as a “speech detection” technique.

In detail, the external voice identification module 552 may identify whether the external voice is included in each frame of the noise signal using the VAD technique. For example, the external voice identification module 552 may identify whether or not the external voice exists in the noise signal in a binary manner using the VAD technique.

In particular, the user voice identification module 560 may identify the probability whether the voice of a user exists in each frame having a predetermined interval, e.g., a duration, by dividing the bone conduction signal into a plurality of frame units having the predetermined frame intervals, e.g., durations, (e.g., frame intervals of 10 ms). For example, the user voice identification module 560 may identify the frame unit in which the probability that the voice exists has a predetermined value (e.g., 0.7) or more as the frame including the voice, e.g., a current frame including the voice. For example, the processor 550 may perform a voice detection method as described in FIG. 6.

FIG. 6 illustrates an example voice detection method 600 according to various embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of voice detection could be used without departing from the scope of this disclosure.

In operation 602, the wearable audio device 500 may identify whether the voice is included in the current frame. For example, the wearable audio device 500 may identify whether the voice is included in the frame of the signal obtained by the microphone 510 and the IMU sensor 520. In an embodiment, the wearable audio device 500 may identify whether the voice is included in each frame having the predetermined interval (e.g., frame interval of 10 ms) among the plurality of the frames of the signals. In addition, if the voice is included in the current frame, the wearable audio device 500 may identify that the frame is the frame corresponding to the voice (speaking=1). On the other hand, if no voice is included in the current frame, the wearable audio device 500 may identify that the frame is not the frame corresponding to the voice (speaking=0).

In operation 604, the wearable audio device 500 may identify whether a prior frame is the frame of the dialog situation. In detail, the wearable audio device 500 may identify that whether the prior frame is the frame of the dialog situation (dialog_detection_old=?) based on the result obtained by a dialog situation identification module (not shown). For example, the wearable audio device 500 may identify whether a region of the frame prior to that of the current frame having the predetermined interval (e.g., frame interval of 30 ms) is that of a dialog situation, no dialog situation, or a humming situation.

If the prior frame is identified as a frame of no dialog situation (dialog_detection_old=0), the wearable audio device 500 may identify whether the current frame is the frame of the dialog situation based on the signals obtained by the IMU sensor 520 in operation 606.

If it is identified that the current frame is not the dialog situation, then in operation 608, the wearable audio device 500 may identify the current situation as no dialog situation (dialog detection=0). In addition, the wearable audio device 500 may identify the region of the current frame as no dialog region (dialog=0).

If the current frame is identified as the frame of the dialog situation, the wearable audio device 500 may identify whether the region of the current frame is a humming region in operation 610.

Additionally, if it is identified that the region of the current frame is the humming region, the wearable audio device 500 may identify the current situation as the humming situation (dialog detection=−1) in operation 612. Further, the wearable audio device 500 may identify the region of the current frame as no dialog region (dialog=0) as in operation 608.

In addition, if it is identified the region of the current frame as no humming region, e.g., a negative result in operation 610, the wearable audio device 500 may identify the current situation as the dialog situation (dialog detection=1) in operation 614. In addition, the wearable audio device 500 may identify the region of the current frame as a dialog region (dialog=1) in operation 622.

If it is identified that the prior frame is the frame of the humming situation (dialog_detection_old=−1) in 604, the wearable audio device 500 may identify whether the current frame includes no voice and the prior frame includes the voice in operation 616.

If it is identified that the current frame includes no voice and the previous frame includes the voice, e.g., a positive result in operation 616, the wearable audio device 500 may identify the current situation as no dialog situation (dialog detection=0) as in operation 608. In addition, if it is identified that the current frame includes the voice or the prior frame includes no voice, e.g., a negative result in operation 616, the wearable audio device 500 may identify that the current situation is the humming situation (dialog detection=−1) as in operation 612.

If the prior frame is identified as the dialog situation (dialog_detection_old=1) in 604, the wearable audio device 500 may identify whether the current frame includes the voice (speaking=1) or whether the predetermined time (e.g., 5 seconds) is not elapsed from the dialog start point in operation 618.

That is, if the current frame includes the voice (speaking=1), e.g., a positive result in operation 618, the wearable audio device 500 may identify that the current situation is the dialog situation (dialog detection=1) in operation 614. In addition, if the predetermined time (e.g., 5 seconds) is not elapsed from the dialog start point e.g., a positive result in operation 618, the wearable audio device 500 may identify that the current situation is the dialog situation (dialog detection=1) in operation 614. In addition, the wearable audio device 500 may identify the region of the current frame as the dialog region (dialog=1) in operation 622.

Alternatively, if the current frame includes no voice (speaking=0), and the predetermined time (e.g., 5 seconds) is elapsed from the dialog start point e.g., a negative result in operation 618, the wearable audio device 500 may identify the current situation as no dialog situation (dialog detection=0) as in operation 608. In addition, the wearable audio device 500 may identify the region of the current frame as no dialog region (dialog=0) in operation 620.

In addition, the wearable audio device 500 may update the result data of operations 620 and 622 in operation 624. That is, the wearable audio device 500 may update whether the current frame includes the dialog situation (dialog_detection) to whether the prior frame includes the dialog situation (dialog_detection_old), and whether the current frame includes the voice (speaking) to whether the prior frame includes the voice (speaking).

Although FIG. 6 illustrates one example voice detection method 600, various changes may be made to FIG. 6. For example, while shown as a series of steps, various steps in FIG. 6 could overlap, occur in parallel, occur in a different order, or occur any number of times. For example, the wearable audio device 500 may continuously repeat operations 602 through 624.

Referring to FIG. 4, operation 404 of the method 400 includes selecting, based on the command received, at least one second wearable audio device 306. For example, the first wearable audio device 302 may receive a command that includes information regarding criteria for selection of the at least one second wearable audio device 306, e.g., device name, group name if selecting more than one secondary wearable device, communication protocols, or other identifying characteristics. The first wearable audio device 302 may then perform a network discovery process, e.g., neighbor awareness networking or an inquiry process, to identify the at least one second wearable audio device 306. Once the at least one second wearable audio device 306 in the network are identified, the first wearable audio device 302 may then select the at least one second wearable audio device 306 that match the information from the received command.

Operation 406 includes initiating, based on the command received, one or more wireless communication channels 308 from the first wearable audio device 302 to the selected at least one second wearable audio device 306. For example, once the at least one second wearable audio device 306 is selected, the first wearable audio device 302 may initiate the one or more wireless communication channels 308 based on relevant protocols, e.g., by sending synchronize (SYN), synchronize-acknowledge (SYN-ACK), and acknowledge (ACK) packets during a TCP handshake between the first wearable audio device 302 and the selected at least one second wearable audio device 306 over a Wi-Fi, Bluetooth, UWB, or any other wireless communication network.

Operation 408 includes transmitting an audio signal from the first wearable audio device 302 to the selected at least one second wearable audio device 306 using the one or more wireless communication channels 308. For example, an audio signal, e.g., the user 304 talking, may be received by the microphone. The received audio signal would be digitized, e.g., using an analog-to-digital converter, then packetized for transmission over the established one or more wireless communication channels 308. Once received by the selected at least one second wearable audio device 306, the signal may be decompressed and converted to an analog signal to be played through a speaker of the selected at least one second wearable audio device 306.

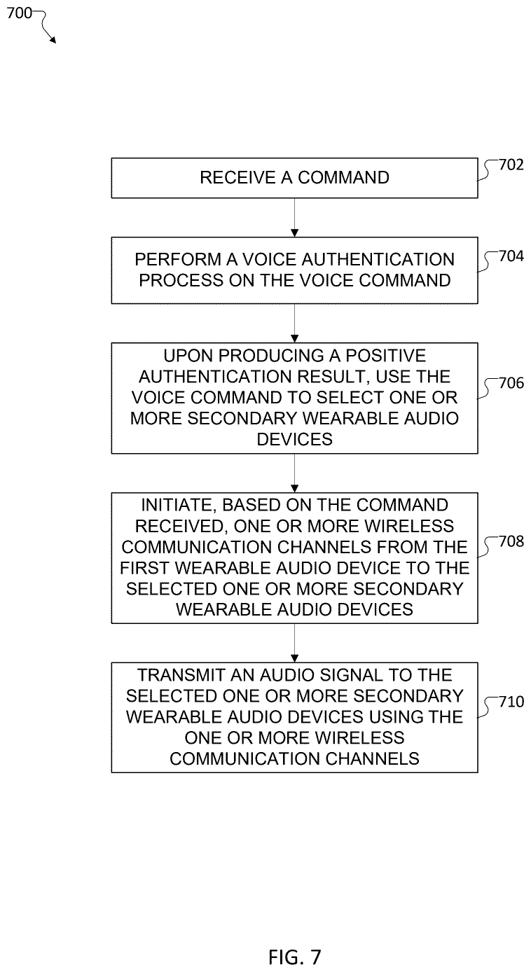

Although FIG. 4 illustrates one example wearable point-to-point communication method 400, various changes may be made to FIG. 4. For example, while shown as a series of steps, various steps in FIG. 4 could overlap, occur in parallel, occur in a different order, or occur any number of times. Further, a point-to-point communication method may include additional steps, e.g., to perform voice authentication, as discussed in FIG. 7.

FIG. 7 illustrates an example point-to-point communication method 700 according to various embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 7, the method 700 begins at operation 702 with receiving a command. As discussed regarding operation 402, the command received may be an input, such as a voice command.

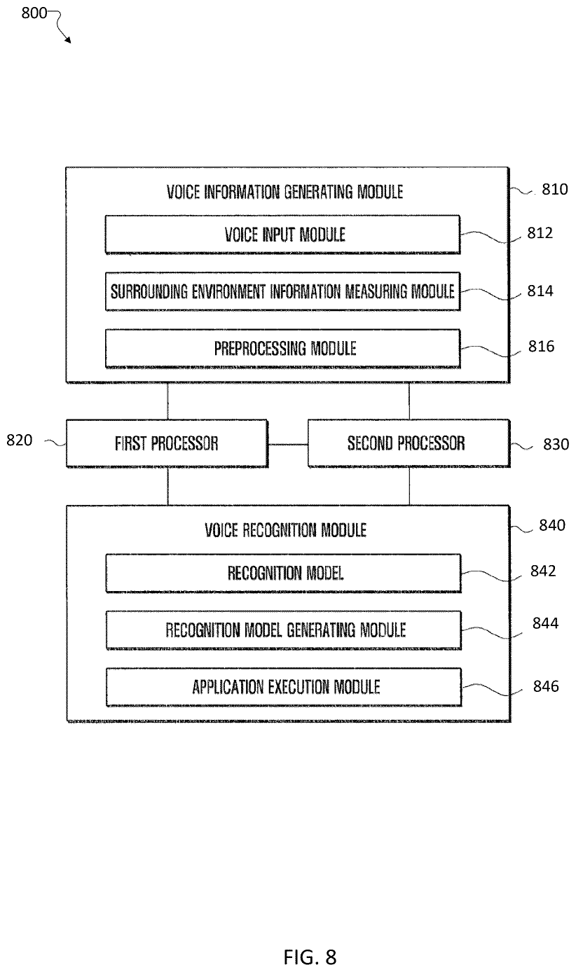

In operation 704, the method 700 includes performing a voice authentication process on the voice command that is received. For example, the 102 may be configured to perform a voice authentication process, such as by including a voice recognition system as described in FIG. 8.

FIG. 8 illustrates an example block diagram of a configuration of a voice recognition system 800 according to various embodiments of the present disclosure. The embodiment of the voice recognition system 800 shown in FIG. 8 is for illustration only. Other embodiments of the voice recognition system 800 could be used without departing from the scope of this disclosure.

The voice recognition system 800 may include a voice information generating module 810, a first processor 820, a second processor 830, and a voice recognition module 840.

The first wearable audio device 302 may receive a voice from the user using the voice recognition system 800. For example, the voice information generating module 810 may receive a voice from the user and generate voice information based on the voice.

The voice information generating module 810 may include a voice input module 812, a surrounding environment information measuring module 814, and a preprocessing module 816.

The first wearable audio device 302 may collect voice of the user by using the voice input module 812. The surrounding environment information measuring module 814 may measure surrounding environment information of the first wearable audio device 302 by using the voice input module 812. For example, the first wearable audio device 302 may measure noise conditions of the surrounding environment by using a microphone (not shown). Specifically, the surrounding environment information measuring module 814 may measure noise level information through the voice input module 812.

The preprocessing module 816 may transform or refine a sound input through the voice input module 812. The preprocessing module 816 may generate more accurate voice information through preprocessing and generate a more accurate recognition model 842 based on the voice information. The preprocessing module 816 may perform the preprocessing on the input sound through echo cancellation, noise reduction, voice activity detection, end-point detection, or automatic gain control. The preprocessing operation may be simultaneously performed with the input of the voice or performed after the input of the voice.

The first processor 820 may perform a speaker-dependent voice authentication through a keyword designated directly by the user. For example, the first processor 820 may perform the voice authentication by comparing a recognition model 842 with the input voice.

Meanwhile, the voice recognition performed by the first processor 820 includes an operation of comparing information reflecting a characteristic of a voice to be recognized with the input voice of the user. At this time, the information reflecting the characteristic of the voice to be recognized may be collectively defined as the recognition model 842. The recognition model 842 may be expressed as a statistical model such as a Hidden Markov Model (HMM), a neural network or the like. When a recognition algorithm such as Dynamic Time Warping (DTW) or Vector Quantization (VQ) is used, the recognition model 842 may be expressed by a feature vector column of a voice signal. When a transformation method such as dimensionality reduction or linear transformation is applied to a recognition process, a parameter used for the transformation may be model information. In addition to the above-listed recognition models, various recognition models may be the recognition model and may include information which may represent a voice to be recognized in common. Further, the recognition model 842 may include attribute information of the input voice. For example, the attribute information may include at least one of a length, a size, a number of phonemes, and a length of phonemes of the input voice.

The first processor 820 may compare attribute information of the input voice with pre-stored attribute information of the recognition model 842. When the pieces of attribute information match each other, the first processor 820 may authenticate the input voice as a pre-stored voice of the user.

When the input voice is identified as the pre-stored voice of the user, the first processor 820 may transmit a wake-up signal for activating the second processor 830. The first processor 820 may change a state of the second processor 830 from a sleep mode to an active mode by using the wake-up signal. Through the change of the state, the second processor 830 may active a voice command function and execute a particular function or application of the electronic device according to the input voice.

The second processor 830 may use more power and more complex functions compared to the first processor 820.

The second processor 830 may receive the wake-up signal from the first processor 820 and activate the recognition command function through the wake-up signal. When the recognition command function is activated, the second processor 830 may execute a particular function or application of the electronic device by using an application execution module 846.

In an embodiment, the second processor 830 loads at least one of the recognition model generating module 844 and the application execution module 846 in response to the wake-up signal generated by the first processor 820 and executes at least one of the recognition model generating module 844 and the application execution module 846.

The voice recognition module 840 may include the recognition model 842, the recognition model generating module 844, and the application execution module 846.

The recognition model generating module 844 may generate the recognition model 842 based on attribute information of the input voice. The recognition model generating module 844 may receive a predetermined keyword from the user through a voice and generate the recognition model 842 by using the collected voice. Meanwhile, an operation of generating the recognition model 842 using the recognition model generating module 844 may be performed by the first processor 820 or the second processor 830. The generated recognition model 842 may be used when voice authentication is performed by the first processor 820.

When the wake-up signal is generated by the first processor 820, the recognition command function of the second processor 830 is activated, so the application execution module 846 may execute a particular function or application of the electronic device after receiving a voice command from the user. Meanwhile, an operation of executing the particular function or application of the electronic device by using the application execution module 846 may be performed by the second processor 830.

The voice recognition performed by the first processor 820 includes an operation of comparing information reflecting a characteristic of a voice to be recognized with the input voice of the user. At this time, the information reflecting the characteristic of the voice to be recognized may be collectively defined as the recognition model 842. The recognition model 842 may be expressed as a statistical model such as a Hidden Markov Model (HMM), a neural network or the like. When a recognition algorithm such as Dynamic Time Warping (DTW) or Vector Quantization (VQ) is used, the recognition model 842 may be expressed by a feature vector column of a voice signal. When a transform method such as dimensionality reduction or linear transformation is applied to a recognition process, a parameter used for the transform may be model information. In addition to the above-listed recognition models, various recognition models may be the recognition model and may include information which may represent a voice to be recognized in common. Further, the recognition model 842 may include attribute information of the input voice. For example, the attribute information may include at least one of a length, a size, a number of phonemes, and a length of phonemes of the input voice.

Referring to FIG. 7, operation 706 of the method 700 includes, upon producing a positive authentication result, using the voice command to select at least one second wearable audio device 306 similar to operation 404 of method 400 in FIG. 4. For example, the first wearable audio device 302 may receive a command that includes information regarding criteria for selection of the at least one second wearable audio device 306, e.g., device name, group name if selecting more than one secondary wearable device, communication protocols, or other identifying characteristics. The first wearable audio device 302 may then perform a network discovery process, e.g., neighbor awareness networking or an inquiry process, to identify the at least one second wearable audio device 306. Once the at least one second wearable audio device 306 in the network are identified, the first wearable audio device 302 may then select the at least one second wearable audio device 306 that match the information from the received command.

Similar to operation 406 of method 400 in FIG. 4, operation 708 includes initiating, based on the command received, one or more wireless communication channels 308 from the first wearable audio device 302 to the selected at least one second wearable audio device 306. For example, once the at least one second wearable audio device 306 is selected, the first wearable audio device 302 may initiate the one or more wireless communication channels 308 based on relevant protocols, e.g., by sending synchronize (SYN), synchronize-acknowledge (SYN-ACK), and acknowledge (ACK) packets during a TCP handshake between the first wearable audio device 302 and the selected at least one second wearable audio device 306 over a Wi-Fi, Bluetooth, UWB, or any other wireless communication network.

Similar to operation 408 of method 400 in FIG. 4, operation 710 includes transmitting an audio signal from the first wearable audio device 302 to the selected at least one second wearable audio device 306 using the one or more wireless communication channels 308. For example, an audio signal, e.g., the user 304 talking, may be received by the microphone. The received audio signal would be digitized, e.g., using an analog-to-digital converter, then packetized for transmission over the established one or more wireless communication channels 308. Once received by the selected at least one second wearable audio device 306, the signal may be decompressed and converted to an analog signal to be played through a speaker of the selected at least one second wearable audio device 306.

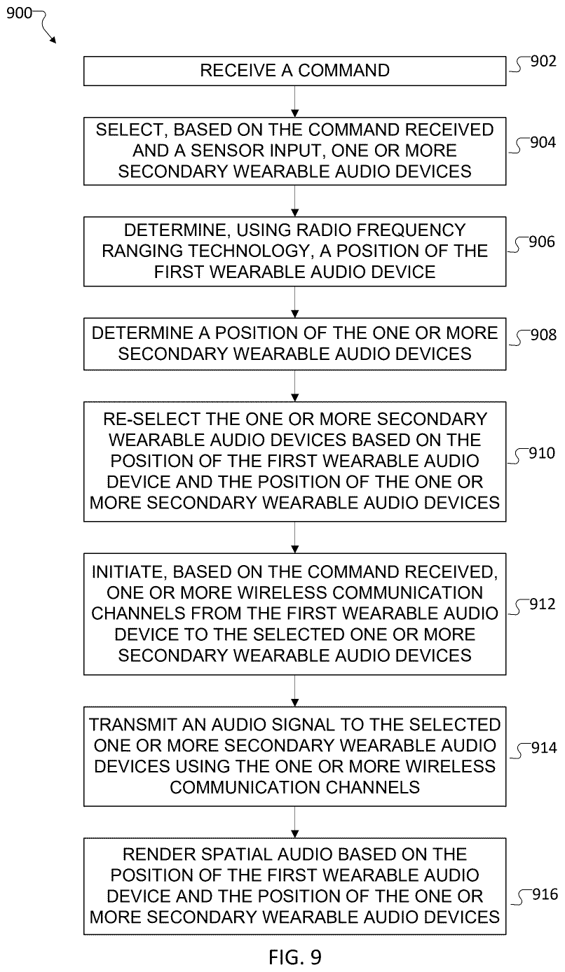

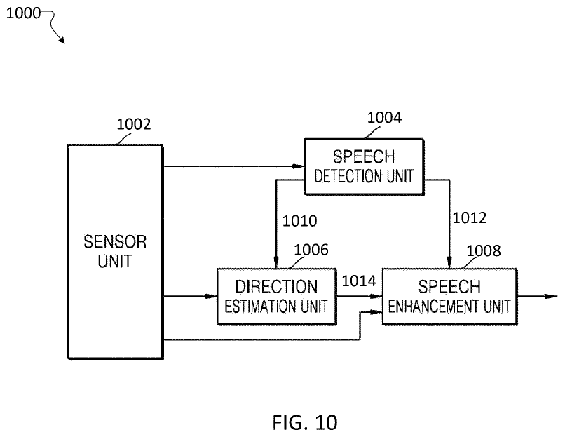

Although FIG. 7 illustrates one example point-to-point communication method 700, various changes may be made to FIG. 7. For example, while shown as a series of steps, various steps in FIG. 7 could overlap, occur in parallel, occur in a different order, or occur any number of times. Further, a point-to-point communication may include steps to select at least one second wearable audio device based on spatial audio rendered at a first wearable audio device as discussed in FIGS. 9 and 10.

FIG. 9 illustrates an example point-to-point communication method 900 for wearable audio devices according to various embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 9, the method 900 begins at operation 902 where a command is received. For example, the first wearable audio device 302 may receive a command by a button press, such as when a user 304 presses a button communicatively coupled to the first wearable audio device 302, either directly or indirectly, such as through a connected device. Alternatively, the first wearable audio device 302 may be configured to receive a command from a user 304 that is a voice command.

In operation 904, the method includes selecting, based on the command received, at least one second wearable audio device 306. For example, the first wearable audio device 302 may receive a command that includes information regarding criteria for selection of the at least one second wearable audio device 306, e.g., device name, group name if selecting more than one secondary wearable device, communication protocols, or other identifying characteristics. Alternatively, the command may include criteria regarding the directionality of the desired at least one second wearable audio device 306. For example, the first wearable audio device 302 may be configured to render spatial audio, such as described in FIG. 10.

FIG. 10 illustrates an example block diagram of a configuration of a spatial audio module 1000 according to various embodiments of the present disclosure. The embodiment of the spatial audio module 1000 shown in FIG. 10 is for illustration only. Other embodiments of the spatial audio module 1000 could be used without departing from the scope of this disclosure.

Referring to FIG. 10, the spatial audio module 1000 includes a sensor unit 1002 (e.g., a sensor, etc.), a speech detection unit 1004 (e.g., a speech detector, etc.), a direction estimation unit 1006 (e.g., a direction estimator, etc.), and a speech enhancement unit 1008 (e.g., a speech enhancer, etc.).

The sensor unit 1002 includes at least one microphone. The sensor unit 1002 may further include a camera, a bone conduction sensor, a proximity sensor, an infrared sensor, an acceleration sensor, or an ultrasonic sensor in addition to the at least one microphone.

The speech detection (SD) unit 1004 detects speech of a speaker by using a signal of the sensor unit 1002. For example, the speech detection unit 1004 detects whether a user has spoken by using a microphone or other sensors.

In operation 906, a position, which may also include direction and orientation data with respect to the receiving wearable device, of the first wearable audio device is determined using radio frequency ranging technology, e.g., short-range RF such as Bluetooth technology, UWB, and Wi-Fi. The position of the first wearable audio device may include a position in space, a position referenced from wearable audio device to another wearable audio device, or a position of the first wearable audio device within itself using sensor data, e.g., IMU sensors, accelerometers, or motion sensors. The position determined in operation 906 allows for the first wearable audio device to determine its position and direction relative to one or more secondary wearable audio devices. In particular, the direction estimation unit 1006, e.g., using target direction estimation (TDE), estimates a direction of the user of the first wearable audio device 302 by using a signal of the sensor unit 1002 and generates direction information indicating the estimated direction. For example, the direction estimation unit 1006 detects a position of a user by using multiple microphones, an image of a camera, or input from a sensor, e.g., from an IMU sensor, an accelerometer, or motion sensor.

The speech enhancement (ENH) unit 1008 enhances speech of a speaker that is input to a microphone. In detail, the speech enhancement unit 1008 receives information indicating whether the user has spoken and direction information, and enhances a speech signal by using the information indicating whether the user has spoken and the direction information.

The speech detection unit 1004 controls operations of the direction estimation unit 1006 and the speech enhancement unit 1008 based on a result of speech detection. The control information 1010 transmitted from the speech detection unit 1004 to the direction estimation unit 1006 may be used to control switching the direction estimation unit 1006 on or off. The control information 1012 transmitted from the speech detection unit 1004 to the speech enhancement unit 1008 may control a filter update of the speech enhancement unit 1008.

The direction estimation unit 1006 transmits direction information to the speech enhancement unit 1008. The direction information 1014 transmitted from the direction estimation unit 1006 to the speech enhancement unit 1008 denotes direction information of a user.

As an input transmitted from the sensor unit 1002 to the speech detection unit 1004, a camera or bone conduction information may be used besides a microphone signal. As an input transmitted from the sensor unit 1002 to the direction estimation unit 1006, camera sensor information may be used in addition to a microphone signal. An input transmitted from the sensor unit 1002 to the speech enhancement unit 1008 may be a microphone signal.

Examples of estimating a direction of speech by using the direction estimation unit 1006 include estimating a direction by using a difference between two or more microphone signals, estimating a direction of arrival (DOA) or time difference of arrival (TDOA) using a speech, recognition of a face of a speaker, detecting movement of the lips of a speaker, recognition of gestures, using an IMU sensor as described above in FIG. 5, or in a multimodal manner in which these methods are combined.

The speech enhancement unit 1008 may include at least one filter. When speech is detected by the speech detection unit 1004, a filter factor is counted, and when no speech is detected by the speech detection unit 1004, noise for noise modeling may be estimated. The speech enhancement unit 1008 may use direction information received from the direction estimation unit 1006 to perform at least one of adjustment of time when a desired signal source arrives at each microphone, correction of a deviation between microphones, and separation of signal sources.

The spatial audio module 1000 may operate also as follows. When a user speaks while a speech recognition mode or a call mode is prepared, the speech detection unit 1004 detects the speech. In a section in which an utterance of the user is detected, the speech detection unit 1004 turns on the direction estimation unit 1006 by using the control information 1010 to search for a direction of the user while the user is speaking, e.g., with input from an IMU sensor, and transmits the direction information 1014 to the speech enhancement unit 1008. Here, filter update of the speech enhancement unit 1008 may be blocked to prevent speech distortion. The speech enhancement unit 1008 corrects a delay between channels by using the received direction information 1014 and performs speech enhancement by adjusting a filter update by using the control information 1012.

According to the spatial audio module 1000, the direction estimation unit 1006 searches for a direction of the user only when the speech detection unit 1004 detects speech, and thus, an exact direction of the user may be determined. If a direction is searched for while no speech has been uttered, an inaccurate direction may be estimated due to noise or the like. The speech enhancement unit 1008 may perform speech enhancement by using exact direction information. Thus, by using the spatial audio module 1000, speech enhancement performance by using direction estimation performance and direction information may be improved. Moreover, if speech is not detected, operations of the direction estimation unit 1006 and the speech enhancement unit 1008 may be stopped, and thus, a gain may be obtained also for computing power of the spatial audio module 1000.

In operation 908, the spatial audio module 1000 may be configured to receive an audio signal, e.g., using an external microphone, and determine the direction information of the received audio signal similar to the direction of the user 304. Alternatively, the first wearable audio device 302 may receive direction information from each of the at least one second wearable audio device 306.

Although FIG. 10 illustrates one example of a spatial audio module, various changes may be made to FIG. 10. For example, a different quantity of direction estimation units may be used to improve accuracy.

Referring to FIG. 9, operation 910 of method 900 includes re-selecting the at least one second wearable audio device 306 based on the direction of the first wearable audio device 302 and the direction of the at least one second wearable audio device 306. For example, the at least one second wearable audio device 306 to be selected may be the at least one second wearable audio device 306 that is beyond a predetermined threshold, e.g., 2 meters, away from the first wearable audio device 302. In another example, the at least one second wearable audio device 306 to be selected may be the at least one second wearable audio device 306 that are generally facing the first wearable audio device 302.

Operation 912 includes initiating, based on the command received, one or more wireless communication channels 308 from the first wearable audio device 302 to the selected at least one second wearable audio device 306. For example, once the at least one second wearable audio device 306 is selected, the first wearable audio device 302 may initiate the one or more wireless communication channels 308 based on relevant protocols, e.g., by sending synchronize (SYN), synchronize-acknowledge (SYN-ACK), and acknowledge (ACK) packets during a TCP handshake between the first wearable audio device 302 and the selected at least one second wearable audio device 306 over a Wi-Fi, Bluetooth, UWB, or any other wireless communication network.

Operation 914 includes transmitting an audio signal from the first wearable audio device 302 to the selected at least one second wearable audio device 306 using the one or more wireless communication channels 308. For example, an audio signal, e.g., the user 304 talking, may be received by the microphone. The received audio signal would be digitized, e.g., using an analog-to-digital converter, then packetized for transmission over the established one or more wireless communication channels 308. Once received by the selected at least one second wearable audio device 306, the signal may be decompressed and converted to an analog signal to be played through a speaker of the selected at least one second wearable audio device 306.

Optionally, operation 916 includes rendering spatial audio based on the position of the first wearable audio device 302 and the position of the at least one second wearable audio device 306 on the audio signal that is transmitted by the first wearable audio device 302. This enables the at least one second wearable audio device 306 to reproduce spatial audio such that a user of the selected one or more secondary wearable devices 306 may hear where the sound is coming from.

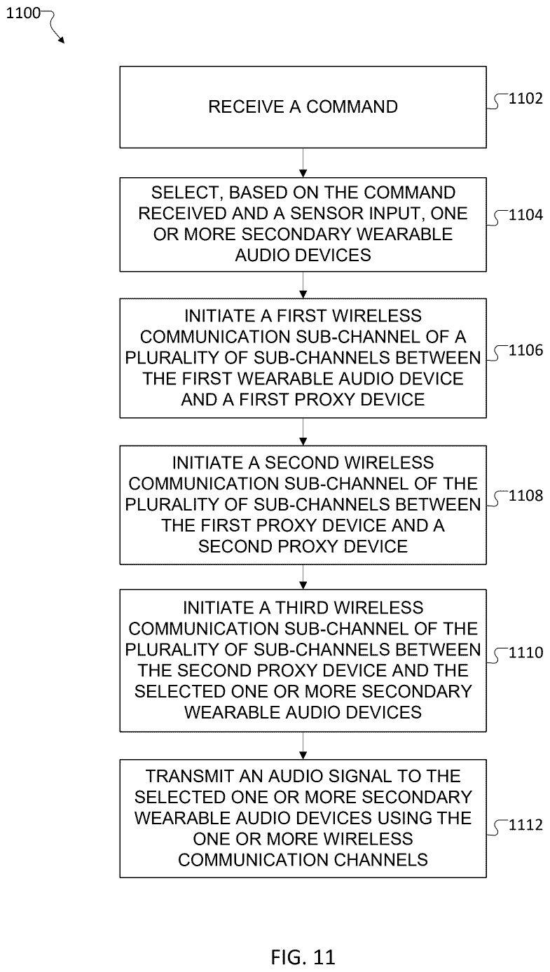

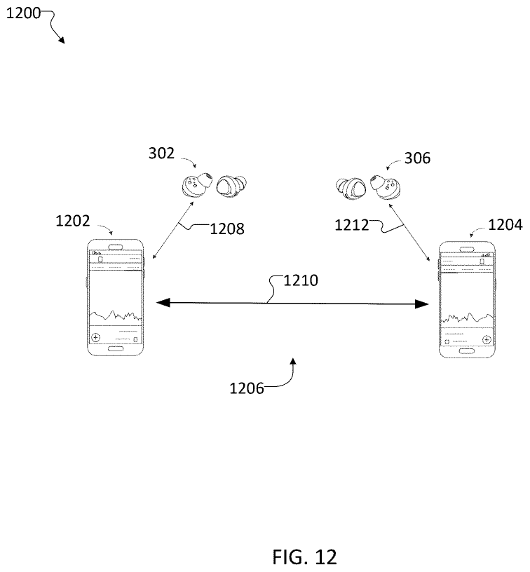

Although FIG. 9 illustrates one example point-to-point communication method for wearable audio devices, various changes may be made to FIG. 9. For example, while shown as a series of steps, various steps in FIG. 9 could overlap, occur in parallel, occur in a different order, or occur any number of times. Further, a point-to-point communication may include steps to establish communication channels between wearable audio devices using proxy devices as described in FIGS. 11 and 12.

FIG. 11 illustrates an example point-to-point communication method 1100 for wearable audio devices according to various embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of tag location determination could be used without departing from the scope of this disclosure.

FIG. 12 illustrates an example communication system 1200 according to various embodiments of the present disclosure. In particular, the communication system 1200 may include components of the system 300 of FIG. 3, e.g., the first wearable audio device 302 and the at least one second wearable audio device 306, and may be configured to perform the communication method 1100.

As illustrated in FIG. 12, the communication system 1200 includes a first wearable audio device 302 and at least one second wearable audio device 306 (one shown). The communication system further includes a plurality of proxy devices, e.g., a first proxy device 1202 and a second proxy device 1204, communicably coupled to the first wearable audio device 302 and the at least one second wearable audio device 306, respectively.

The method 1100 begins at operation 1102, when a command is received. For example, the first wearable audio device 302 may receive a command by a button press, such as when a user 304 presses a button communicatively coupled to the first wearable audio device 302, either directly or indirectly, such as through a connected device, e.g., the first proxy device 1202. Alternatively, the first wearable audio device 302 may be configured to receive a command from a user 304 that is a voice command.

Operation 1104 includes selecting, based on the command received, at least one second wearable audio device 306. For example, the first wearable audio device 302 may receive a command that includes information regarding criteria for selection of the at least one second wearable audio device 306, e.g., device name, group name if selecting more than one secondary wearable device, communication protocols, or other identifying characteristics. The first wearable audio device 302 may then perform a network discovery process, e.g., neighbor awareness networking or an inquiry process, to identify the at least one second wearable audio device 306. Once the at least one second wearable audio device 306 in the network are identified, the first wearable audio device 302 may then select the at least one second wearable audio device 306 that match the information from the received command. Alternatively, the at least one second wearable audio device 306 may be selected based on the position information of the first wearable audio device 302 and at least one second wearable audio device 306, similar to the process described regarding FIG. 9. In another example, the first proxy device 1202 may select the at least one second wearable audio device 306 based on information provided by the second proxy device 1204 for each of the at least one second wearable audio device 306.

Operation 1106 includes initiating a plurality of sub-channels 1206 to establish a communication channel between the first wearable audio device 302 and the at least one second wearable audio device 306. In particular, operation 1106 includes initiating a first wireless communication sub-channel 1208 of the plurality of sub-channels 1206 between the first wearable audio device 302 and the first proxy device 1202.

Optionally, initiating one or more wireless communication channels, e.g., the plurality of sub-channels 1206, from the first wearable audio device 302 to the selected at least one second wearable audio device 306 may include sending a command frame to one or more connected devices, e.g., the second proxy device 1202 or other devices operably connected to the selected at least one second wearable audio device 306 to cease audio output other applications, e.g., a video playing application, running on the one or more connected devices.

In operation 1108, a second wireless communication sub-channel 1210 of the plurality of sub-channels 1206 is initiated between the first proxy device 1202 and the second proxy device 1204. Similarly, in operation 1110, a third wireless communication sub-channel 1212 of the plurality of sub-channels 1206 is initiated between the second proxy device 1204 and the selected at least one second wearable audio device 306. Operations 1106, 1108, and 1110 need not occur consecutively, but may occur in any order and concurrently in any desired combination.

Once the plurality of sub-channels 1206 are initiated between the first wearable audio device 302, the first proxy device 1202, the second proxy device 1204, and the at least one second wearable audio device 306, the electronic devices may perform any additional necessary process. For example, once the at least one second wearable audio device 306 is selected, the first wearable audio device 302 may initiate the one or more wireless communication channels 308 based on relevant protocols, e.g., by sending synchronize (SYN), synchronize-acknowledge (SYN-ACK), and acknowledge (ACK) packets during a TCP handshake between the first wearable audio device 302 and the selected at least one second wearable audio device 306 over a Wi-Fi, Bluetooth, UWB, or any other wireless communication network.

Operation 1112 includes transmitting an audio signal from the first wearable audio device 302 to the selected at least one second wearable audio device 306 using the one or more wireless communication channels 308. For example, an audio signal, e.g., the user 304 talking, may be received by the microphone. The received audio signal would be digitized, e.g., using an analog-to-digital converter, then packetized for transmission over the established one or more wireless communication channels 308 using the plurality of sub-channels 1206. Once received by the selected at least one second wearable audio device 306, the signal may be decompressed and converted to an analog signal to be played through a speaker of the selected at least one second wearable audio device 306.

Although FIG. 11 illustrates one example point-to-point communication method for wearable audio devices, various changes may be made to FIG. 11. For example, while shown as a series of steps, various steps in FIG. 11 could overlap, occur in parallel, occur in a different order, or occur any number of times.

The above flowcharts illustrate example methods that may be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving a command at a first wearable audio device;
selecting, based on the command received at the first wearable audio device and a sensor input, at least one second wearable audio device;
initiating, based on the command received at the first wearable audio device, one or more wireless communication channels from the first wearable audio device to the selected at least one second wearable audio device; and
transmitting an audio signal from the first wearable audio device to the selected at least one second wearable audio device using the one or more wireless communication channels.

2. The method of claim 1, further comprising:
determining, using radio frequency ranging technology, a position of the first wearable audio device;
determining a position of the at least one second wearable audio device; and
rendering spatial audio based on the position of the first wearable audio device and the position of the at least one second wearable audio device.

3. The method of claim 2, further comprising:
re-selecting the at least one second wearable audio device based on the position of the first wearable audio device and the position of the at least one second wearable audio device.

4. The method of claim 1, wherein receiving the command at the first wearable audio device comprises receiving an input from a button press.

5. The method of claim 1, wherein receiving the command at the first wearable audio device comprises receiving a voice command.

6. The method of claim 5, wherein receiving a voice command comprises:
performing a voice authentication process on the voice command; and
upon producing a positive authentication result, using the voice command to select at least one second wearable audio device.

7. The method of claim 1, wherein initiating one or more wireless communication channels from the first wearable audio device to the selected at least one second wearable audio device comprises sending a command frame to one or more connected devices to cease audio output from other applications running on the one or more connected devices.

8. The method of claim 1, wherein initiating one or more wireless communication channels from the first wearable audio device to the selected at least one second wearable audio device comprises:
initiating a first wireless communication sub-channel of a plurality of sub-channels between the first wearable audio device and a first proxy device;
initiating a second wireless communication sub-channel of the plurality of sub-channels between the first proxy device and a second proxy device; and
initiating a third wireless communication sub-channel of the plurality of sub-channels between the second proxy device and the selected at least one second wearable audio device.

9. An electronic device, comprising:
a microphone configured to receive an audio signal;
a sensor configured to receive a sensor input; and
a processor operably coupled to the microphone and the sensor, configured to cause the electronic device to:
receive a command;
select, based on the command received and the sensor input, at least one second wearable audio device;
initiate, based on the command received, one or more wireless communication channels from the electronic device to the selected at least one second wearable audio device; and
transmit the audio signal to the selected at least one second wearable audio device using the one or more wireless communication channels.

10. The electronic device of claim 9, wherein the processor is further configured to cause the electronic device to:
determine, using radio frequency ranging technology, a position of the electronic device;
determine a position of the at least one second wearable audio device; and
render spatial audio based on the position of the electronic device and the position of the at least one second wearable audio device.

11. The electronic device of claim 10, wherein the processor is further configured to cause the electronic device to:
re-select the at least one second wearable audio device based on the position of the electronic device and the position of the at least one second wearable audio device.

12. The electronic device of claim 10, wherein the processor, when causing the electronic device to receive the command, is further configured to cause the electronic device to receive an input from a button press.

13. The electronic device of claim 10, wherein the processor, when causing the electronic device to receive the command, is further configured to cause the electronic device to receive a voice command.

14. The electronic device of claim 10, wherein the processor, when causing the electronic device to initiate one or more wireless communication channels to the selected at least one second wearable audio device, is further configured to cause the electronic device to:
initiate a first wireless communication sub-channel of a plurality of sub-channels between the electronic device and a first proxy device;
initiate a second wireless communication sub-channel of the plurality of sub-channels between the first proxy device and a second proxy device; and
initiate a third wireless communication sub-channel of the plurality of sub-channels between the second proxy device and the selected at least one second wearable audio device.

15. A non-transitory computer-readable medium comprising program code, that when executed by at least one processor of an electronic device, causes the electronic device to:
receive a command;
select, based on the command received and a sensor input, at least one second wearable audio device;
initiate, based on the command received, one or more wireless communication channels from the electronic device to the selected at least one second wearable audio device; and
transmit an audio signal to the selected at least one second wearable audio device using the one or more wireless communication channels.

16. The non-transitory computer-readable medium of claim 15, further comprising program code, that when executed by the at least one processor of the electronic device, causes the electronic device to:
determine, using radio frequency ranging technology, a position of the electronic device;
determine a position of the at least one second wearable audio device; and
render spatial audio based on the position of the electronic device and the position of the at least one second wearable audio device.

17. The non-transitory computer-readable medium of claim 15, further comprising program code, that when executed by the at least one processor of the electronic device, causes the electronic device to:
re-select the at least one second wearable audio device based on a position of the electronic device and a position of the at least one second wearable audio device.

18. The non-transitory computer-readable medium of claim 17, wherein the program code, that when executed by the at least one processor, causes the electronic device to receive the command, further comprises program code, that when executed by the at least one processor, causes the electronic device to receive a voice command.

19. The non-transitory computer-readable medium of claim 18, wherein the program code, that when executed by the at least one processor, causes the electronic device to receive a voice command, comprises program code, that when executed by the at least one processor, causes the electronic device to:
perform a voice authentication process on the voice command; and
upon producing a positive authentication result, use the voice command to select at least one second wearable audio device.

20. The non-transitory computer-readable medium of claim 15, wherein the program code, that when executed by the at least one processor, causes the electronic device to initiate one or more wireless communication channels to the selected at least one second wearable audio device, comprises program code, that when executed by the at least one processor, causes the electronic device to:
initiate a first wireless communication sub-channel of a plurality of sub-channels between the electronic device and a first proxy device;
initiate a second wireless communication sub-channel of the plurality of sub-channels between the first proxy device and a second proxy device; and
initiate a third wireless communication sub-channel of the plurality of sub-channels between the second proxy device and the selected at least one second wearable audio device.
